(19) United States
(12) Patent Application Publication
(10) Pub. No.: US 2008/0052368 A1
(43) Pub. Date: Feb. 28, 2008

(54) SYSTEM AND METHOD TO SHUFFLE AND REFILL CONTENT

(75) Inventors: Tomas I. Rahkonen, Kista (SE); Johan F. Gulliksson, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: Sony Ericsson Mobile Communications AB, Lund (SE)

(21) Appl. No.: 11/470,360

(22) Filed: Sep. 6, 2006

Related U.S. Application Data
(60) Provisional application No. 60/823,713, filed on Aug. 28, 2006.

(51) Int. Cl. G06F 15/16; G06F 15/167

(52) U.S. Cl. 709/212; 709/200; 455/418; 709/213

(57) ABSTRACT

Disclosed is a system and method for transmitting network-based content from a network to a mobile telephone. The system and method generally provides the mobile telephone requesting information from a remote source. The request generally includes the amount of available memory in the mobile telephone. Optionally, the request may include one or more user preferences. The request is transmitted from the mobile telephone to the remote source. In response, the mobile telephone receives content based upon the request for content, wherein the received content corresponds to a predetermined portion of the available memory. The received content is stored in memory. When the user stores additional information in memory, the memory is dynamically updated. In another embodiment the content of is dynamically updated based upon a predetermined time and/or event.

### RELATED APPLICATION DATA

The present application claims the benefit of U.S. Provisional Application Ser. No. 60/823,713, filed Aug. 28, 2006, the disclosure of which is herein incorporated by reference in its entirety.

### TECHNICAL FIELD OF THE INVENTION

The present invention relates to electronic equipment and, more particularly to a system and method for shuffling and refilling available content on electronic equipment.

### DESCRIPTION OF THE RELATED ART

Mobile telephones have evolved from voice-only electronic devices to multi-functional electronic devices. For example, mobile telephones may now function as electronic organizers, digital cameras, playback devices (e.g., MP3 players, CD players, DVD players, etc.), video game terminals, etc. Moreover, mobile telephones are not only used for voice communications, but they also are used in a variety of other forms (e.g., instant messaging applications, sharing photographs, gaining access to information on the Internet, E-mail, etc).

Such multi-functional electronic devices typically require a memory to store multimedia content. One drawback with conventional mobile telephones is the static nature of the memory contents. Generally, it takes significant and time consuming user interaction to alter memory contents of a conventional mobile telephone. Accordingly, a user may be reluctant to take advantage of new and/or unknown products or services made available to the user. Another drawback with conventional mobile telephones is the expense in downloading such new products or services over a mobile telephone network.

### SUMMARY

It is desirable for users of mobile telephones to utilize the full contents of the memory provided on a mobile telephone. It is also desirable for mobile telephone network operators to provide an efficient and convenient method for users to sample new products and/or services made available to the user of the mobile telephone. Thus, a strong need exists for a system and method for shuffling and/or refilling multimedia content in the memory of a mobile telephone with a minimal amount of user interaction.

One aspect of the present invention relates to a method for downloading content to a mobile telephone, the method comprising: determining an amount of available memory in a mobile telephone; transmitting a request for content from the mobile telephone to an external source, wherein the request includes the amount of available memory in the mobile telephone; receiving content based upon the request for content, wherein the received content corresponds to a predetermined portion of the available memory; storing the received content in memory; storing user information in the memory; and dynamically updating the memory when an associated users stores additional information in memory.

According to an aspect of the invention, the request for content includes one or more user preferences.

According to an aspect of the invention, the request is transmitted at a predetermined time.

According to an aspect of the invention, the request is automatically transmitted.

According to an aspect of the invention, the request is automatically transmitted upon detection of wireless local area network.

According to an aspect of the invention, the request is automatically transmitted upon connecting the electronic equipment to a personal computer.

According to an aspect of the invention, the request is manually selected by an associated user of the electronic equipment.

According to an aspect of the invention, the request is manually selected by an associated user action.

According to an aspect of the invention, the request is transmitted after a threshold percentage of the content has been sampled by the associated user.

According to an aspect of the invention, the external source is a remote server.

According to an aspect of the invention, the external source is a personal computer.

According to an aspect of the invention, the content is received through a mobile telephone network.

According to an aspect of the invention, the content is received through a local area network adapter.

According to an aspect of the invention, the local area network adapter is a wireless local area network adapter.

One aspect of the present invention relates to a method for managing content stored in a mobile telephone, the method comprising: transmitting a request for content from the mobile telephone to an external source, wherein the request includes an amount of memory available on the mobile telephone; receiving content based upon the request for content, wherein the received content corresponds to a substantial portion of the memory available on the mobile telephone; storing the received content in memory; and dynamically updating the memory based upon a predetermined time and/or event.

According to an aspect of the invention, wherein the event is sampling of the content a predetermined number of times.

According to an aspect of the invention, the predetermined time corresponds to a time when access to a network is free and/or a provided at a fee less than a standard fee for access to the network.

Another aspect of the invention relates to a computer program stored on a machine readable medium, the program being suitable for requesting content from a remote source, wherein when the program is loaded in memory in the mobile telephone and executed causes the mobile telephone to transmits a request for content from the mobile telephone to an external source, wherein the request includes an amount of memory available on the mobile telephone, receive content based upon the request for content, wherein the received content corresponds to a substantial portion of the memory available on the mobile telephone; storing the received content in memory; and dynamically updating the memory based upon a predetermined time and/or event.

According to an aspect of the invention, the request includes at least user preference.

According to an aspect of the invention, the user preference relates to content that a user may be inclined to purchase in the future.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary block diagram of a mobile telephone and headset in accordance with aspects of the present invention.

FIG. 2 is an exemplary schematic diagram of a mobile telephone in accordance with aspects of the present invention.

FIG. 3 is an exemplary block diagram of a wireless network in accordance with aspects of the present invention.

FIG. 4 is an exemplary schematic diagram of a server in accordance with aspects of the present invention.

FIG. 5 is an exemplary block diagram of a memory management in accordance with aspects of the present invention.

FIG. 6 is an exemplary method in accordance with aspects of the present invention.

FIGS. 7A-7F are block diagrams of an exemplary memory management method in accordance with aspects of the present invention.

FIG. 8 is an exemplary method in accordance with aspects of the present invention.

### DETAILED DESCRIPTION OF EMBODIMENTS

The present invention is directed to a system and method for automatically filling memory of a mobile telephone with content for the consumer to consume. The content may be shuffled and/or re-filled based upon the user's preferences, the content provider's preferences, the mobile telephone network operator's preferences or any other desirable manner. The amount of memory that is used for shuffling and re-filling content in memory is dynamically changed. As the user adds and/or deletes other content, e.g., information stored by the user, such as contact information, images taken using phone camera, etc., the amount of available for shuffling and/or re-filling is reduced.

The term “content” as used herein should be interpreted broadly to include, for example, multimedia content, application content, data content, etc. The term “remote source” should also be interpreted broadly to mean any electronic source not housed with the mobile telephone. Such remote sources may include, for example, a personal computer, a server, a media server, a content server, an electronic storage medium, a global positioning system, etc. The term “shuffle” means “to rearrange”. The term “re-fill” means “to fill again.”

The invention is described primarily in the context of a mobile telephone. However, it will be appreciated that the invention is not intended to relate solely to a mobile telephone and can relate to any type of electronic equipment. Other types of electronic equipment that may benefit from aspects of the present invention include playback devices having at least audio playback capability or video playback capability in addition to audio playback capability. Exemplary playback devices include MP3 players, CD players and DVD players.

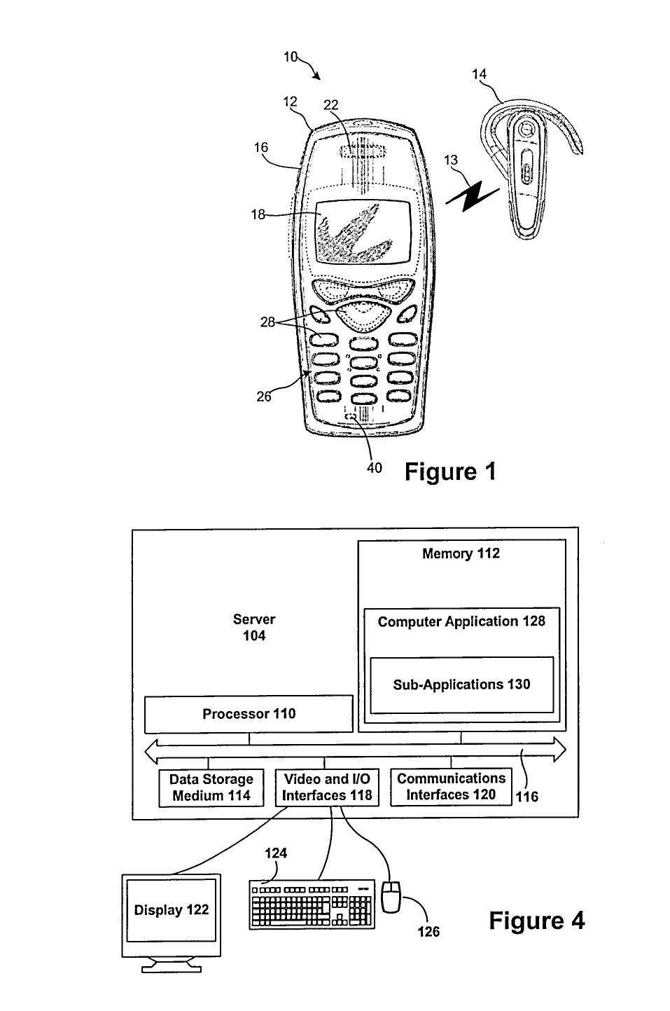

Referring to FIG. 1, an electronic equipment assembly 10 is shown in accordance with the present invention. The illustrated electronic equipment assembly 10 includes electronic equipment 12 and, optionally, may include a wired or wirelessly coupled electronic equipment accessory 14. The electronic equipment 14 is generally coupled to the electronic equipment by a link 13. The link 13 may be a wired link or a wireless link (e.g. Bluetooth) depending on the operating characteristics of the electronic equipment accessory 14. The electronic equipment 12 in the exemplary embodiment is a mobile telephone and will be referred to as the mobile telephone 12. The mobile telephone 12 is shown as having a “brick” or “block” design type housing 16, but it will be appreciated that other type housings, such as a clamshell housing or a slide-type housing, may be utilized without departing from the scope of the invention.

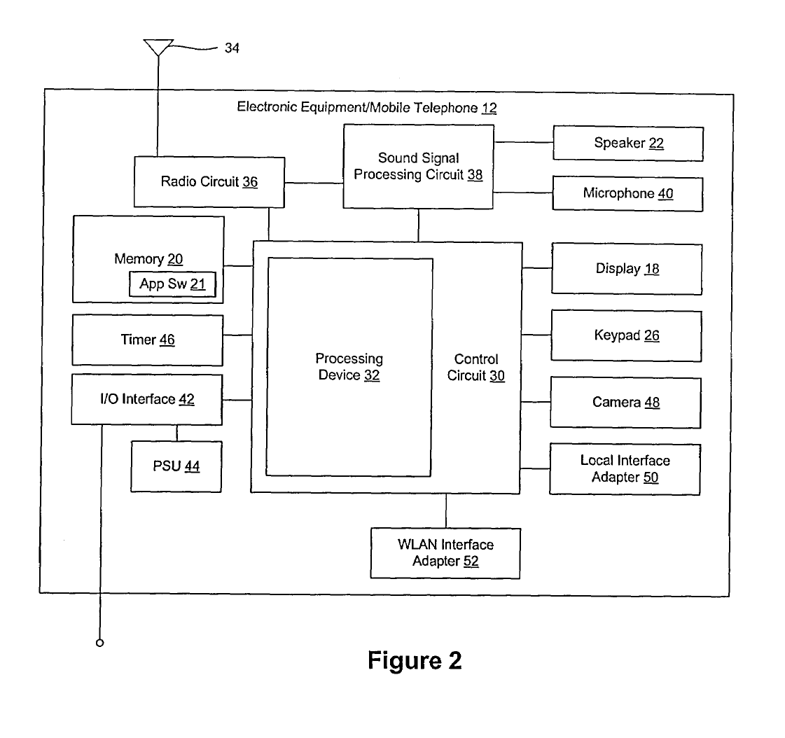

The mobile telephone 12 includes a display 18. The display 18 presents information to a user such as operating state, time, telephone numbers, contact information, various navigational menus, user information, available services and/or products, etc., which generally enable the user to utilize the various features of the mobile telephone 12. The display 18 may also be used to visually display content accessible by the mobile telephone 12 from one or more remote sources (e.g., a personal computer, a server, a media server, a content server, an electronic storage medium, a global positioning system, etc.). The displayed content may include audio and/or video presentations stored locally in memory 20 (FIG. 2) of the mobile telephone 12 and/or stored remotely from the mobile telephone 12 (e.g., on a remote storage device, a media server, remote personal computer, etc.). Such presentations may be derived, for example, from multimedia files, including audio and/or video files, from a received mobile radio and/or television signal, etc. In many situations, the video presentations are accompanied by audio presentations. For example, the displayed video component may be a “music video” and the corresponding audio component may be music intended to be synchronized with the video component. As another example, the displayed video component may correspond to a received mobile television signal and the corresponding audio component may be speech and/or music intended to be synchronized with the video component. The audio component may be broadcast to the user with a speaker 22 of the mobile telephone 12. Alternatively, the audio component may be broadcast to the user with a speaker 24 (FIG. 2) of the headset 14.

The mobile telephone 12 further includes a keypad 26 that provides for a variety of user input operations. For example, the keypad 26 may include alphanumeric keys 28 for allowing entry of alphanumeric information such as telephone numbers, phone lists, contact information, notes, etc. In addition, the keypad 26 typically may include special function keys such as a “call send” key for initiating or answering a call, and a “call end” key for ending, or “hanging up” a call. Special function keys may also include menu navigation keys, for example, for navigating through a menu displayed on the display 18 to select different telephone functions, profiles, services, products, settings, etc., as is conventional. Other keys associated with the mobile telephone 12 may include a volume key, audio mute key, an on/off power key, a web browser launch key, a camera key, etc. Keys or key-like functionality may also be embodied as a touch screen associated with the display 18.

The mobile telephone 12 includes conventional call circuitry that enables the mobile telephone 12 to establish a call and/or exchange signals with a called/calling device, typically another mobile telephone or landline telephone. However, the called/calling device need not be another telephone, but may be some other device such as an Internet web server, content providing server, etc.

Referring to FIG. 2, a functional block diagram of the electronic equipment assembly 10 is illustrated. The mobile telephone 12 includes a primary control circuit 30 that is configured to carry out overall control of the functions and operations of the mobile telephone 12. The control circuit 30 may include a processing device 32, such as a CPU, microcontroller or microprocessor. The processing device 32 executes code stored in a memory (not shown) within the control circuit 30 and/or in a separate memory, such as memory 20, in order to carry out operation of the mobile telephone 12. The memory 20 may be, for example, a buffer, a flash memory, a hard drive, a removable media, a volatile memory and/or a non-volatile memory. The memory 20 is operable to store user information and network based content. User information may include content that is selected or otherwise stored on the mobile telephone 12 by the user. Such information may include, for example, photographs, contact information, services, products, songs, movies, network based content that is saved or otherwise stored by the user, etc., i.e., content that the user manually caused to be stored on the mobile telephone 12. Network based content may include content that is caused to be downloaded from a remote source. Such content may include, for example, new services, new products, sample media, pod casts, movies, games, video clips, audio books, etc. As explained in detail below, the processing device 32 executes code to carry out various functions of the mobile telephone 12, including shuffling and refilling content stored in memory 20 and dynamically updating the memory contents based on the user saving additional information to the memory 20.

As shown in FIG. 2, the mobile telephone 12 is capable of storing application software, including a content management application 21 in memory 20. The content management application 21 is generally coupled to the processor 32, which is programmed to perform the functionality described herein.

Continuing to refer to FIGS. 1 and 2, the mobile telephone 12 includes an antenna 34 coupled to a radio circuit 36. The radio circuit 36 includes a radio frequency transmitter and receiver for transmitting and receiving signals via the antenna 34 as is conventional. The mobile telephone 12 further includes a sound signal processing circuit 38 for processing the audio signal transmitted by/received from the radio circuit 36. Coupled to the sound processing circuit 38 are the speaker 22 and a microphone 40 that enable a user to listen and speak via the mobile telephone 12 as is conventional. The radio circuit 36 and sound processing circuit 38 are each coupled to the control circuit 30 so as to carry out overall operation.

The mobile telephone 12 also includes the aforementioned display 18 and keypad 26 coupled to the control circuit 30. The mobile telephone 12 further includes an I/O interface 42. The I/O interface 42 may be in the form of typical mobile telephone I/O interfaces, such as a multi-element connector at the base of the mobile telephone 12. As is typical, the I/O interface 42 may be used to couple the mobile telephone 12 to a battery charger to charge a power supply unit (PSU) 44 within the mobile telephone 12. In addition, or in the alternative, the I/O interface 42 may serve to connect the mobile telephone 12 to a wired personal hands-free adaptor, to a personal computer or other device via a data cable, etc. The mobile telephone 12 may also include a timer 46 for carrying out timing functions. Such functions may include timing the durations of calls, generating the content of time and date stamps, etc.

The mobile telephone 12 may include various built-in accessories, such as a camera 48 for taking digital pictures. Image files corresponding to the pictures may be stored in the memory 20. In one embodiment, the mobile telephone 12 also may include a position data receiver (not shown), such as a global positioning satellite (GPS) receiver, Galileo satellite system receiver or the like.

To establish wireless communication with other locally positioned devices, such as the headset 14, another mobile telephone, a computer, etc., the mobile telephone 12 may include a local wireless interface adapter 50, such as a Bluetooth adaptor.

To establish communications with network-based content, the mobile telephone 12 may further include a wireless local area network interface adapter 52. Preferably, the WLAN adapter 52 is compatible with one or more IEEE 802.11 protocols (e.g., 802.11(a), 802.11(b) and/or 802.11(g), etc.) and allows the mobile telephone 12 to acquire a unique identifier (e.g., MAC and IP addresses) on an associated network and communicate with one or more devices on the network, assuming the user has the appropriate privileges and/or has been properly authenticated.

The mobile telephone 12 may be configured to operate in a wide area communications system. The system can include one or more servers or call control elements for managing calls placed by and destined to the mobile telephone 12, transmitting network-based content (e.g., image files, audio files, video files, services, products, information, etc.) to the mobile telephone 12 and carrying out any other support functions. The server may communicate with the mobile telephone 12 via a network and a transmission medium. The transmission medium may be any appropriate device or assembly, including, for example, a communications tower, another mobile telephone, a wireless access point, a router, a satellite, etc. Portions of the network may include wired and/or wireless transmission pathways.

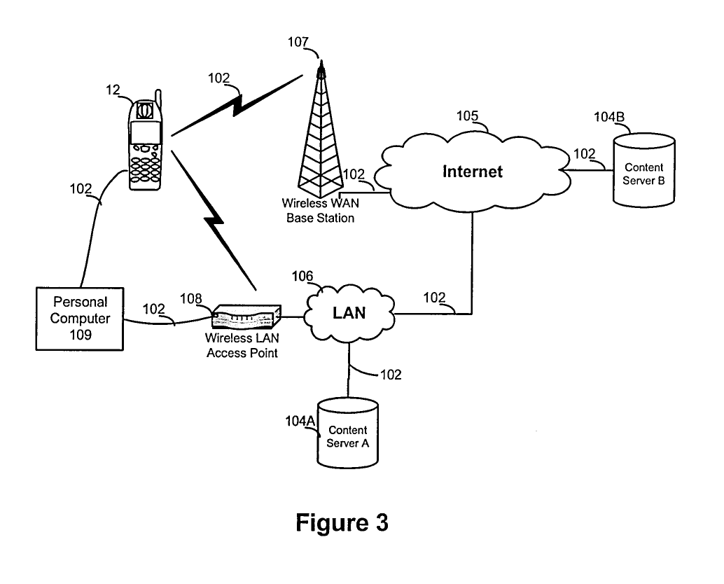

An exemplary network 100 in accordance with the present invention is illustrated in FIG. 3. The network 100 may include one or more communication media 102, one or more content servers 104 (e.g., 104A, 104B), wide area network (WAN) 105 (e.g., Internet), a local area network (LAN) 106, at least one wireless LAN access point (AP) 108, a WAN base station 107, and a mobile telephone 12. Although the content server 104A is shown as being outside of the LAN 106, this is for illustrative purposes only. One of ordinary skill in the art will readily appreciate that the content server 104A may be located within the LAN 106 depending on the specific network topology. One of ordinary skill in the art will also appreciate that the exemplary LAN 106 may be a wireless local area network, a wide area network, personal-area access technology (e.g., wireless local area network, cellular network, WiMax, ultra wideband network, etc.) and/or a public network (e.g., the Internet).

The communication medium 102 can take the form of any medium that permits electronic devices to exchange information or data. For instance, the communication media 102 may be a wired communications medium, such as Ethernet or a wireless communications medium, such as IEEE 802.11(a), 802.11(b) or 802.11(g). In addition, the communication media 102 may also be a combination of wired and wireless communications mediums, as illustrated in FIG. 3. One of ordinary skill in the art will readily appreciate that any communications medium allowing the functionality described herein shall be deemed to be within the scope of the present invention. Preferably the communications medium 102 can support a variety of network protocols including, for example, TCP/IP, UPnP, and the like.

As shown in FIG. 3, the mobile telephone 12 may receive network-based content from content server 104A from the access point 108 through local area network (LAN) 106. In one embodiment, the network-based content is transmitted wirelessly and received by WLAN interface adapter 52 of the mobile telephone 12. In another embodiment, the mobile telephone 12 is linked to the personal computer 109 through any suitable communication link. Suitable communication links may include, for example, USB, FireWire, serial, parallel, Bluetooth, etc. In such cases, the network-based content is downloaded to personal computer 109 and transmitted to the mobile telephone 12.

In addition, the mobile telephone 12 may receive network-based content from content server B through the base station 107 via Internet 105 and wireless WAN base station 107. In addition, the mobile telephone 12 may receive network-based content from content server B through access point 108 via LAN 106. In addition, the personal computer 109 may also transmit the content from content server B via Internet 105 and LAN 106.

In another embodiment, the mobile telephone 12 may receive network-based content directly from personal computer 109. In such cases, the network-based content has been previously stored on personal computer 109.

FIG. 4 illustrates a schematic block diagram of an exemplary content server 104 (e.g., content server A, content server B, etc.). The content server 104 may be any type of server. Preferably, the content server 104 is a media server that is compatible with protocols developed by the Internet Engineering Task Force (IETF) including IP, TCP, UDP, RTP, HTTP and the like. The content server 104 generally includes a processor 110, a memory 112, a data storage medium 114, a local interface 116, video and input/output interfaces 118, and various communication interfaces 120. The content server 104 may include optionally a display 122, a keyboard 124, and a user input device 126 (e.g., a computer mouse).

The content server 104 is capable of executing one or more computer applications 128 in accordance with aspects of the present invention. In one embodiment, computer applications 128 include at least one application that is capable of transmitting network-based content (e.g., audio files, video files, image files, pod casts, video clips, audio books, services, subscription based services, etc.) to the mobile telephone 12. The multimedia content may be stored in the data storage medium 114 or a remote storage medium (not shown) that is communicatively coupled to the content server 104.

As stated above, the network-base content (also referred to herein as multimedia content) may take any form and may be stored in any suitable file format. The content server 104 may also store communications software, which is capable of converting the network based content stored on the content server 104 and/or the remote storage medium to a format that can be rendered locally and/or remotely by the requesting device. Alternatively, the content server 104 may provide the network based content in a known format and allow the requesting device to perform any necessary conversion.

The computer application 128 may be logically associated with or call one or more additional computer applications or one or more sub-computer applications 130, which generally include compilations of executable code. In one embodiment, the computer application 128, and/or the sub-applications 130 are embodied as one or more computer programs (e.g., one or more software applications including compilations of executable code). The computer program(s) can be stored on a data storage medium or other computer readable medium, such as a magnetic or optical storage device (e.g., hard disk, CD-ROM, DVD-ROM, etc.).

To execute the computer application 128 and associated sub-applications 130, the content server 104 can include one or more processors 110 used to execute instructions that carry out a specified logic routine(s). Preferably, the content server 104 is based on a client-server architecture and may serve multiple clients. However, one of ordinary skill in the art will readily appreciate that any combination of computers having the functionality described herein shall be deemed to be within the scope of the present invention. Preferably, the content server 104 is a media server that is compatible with one or more protocols developed by the Internet Engineering Task Force (IETF) including, for example, IP, TCP, UDP, RTP, HTTP and the like.

The content server 104 may have a memory 112 for storing data, software, logic routine instructions, computer programs, files, operating system instructions, multimedia content and the like. As illustrated in FIG. 4, the computer application 128 and sub-applications 130 can be stored in the memory 112. The memory 112 can comprise several devices and includes, for example, volatile and non-volatile memory components. Accordingly, the memory 112 can include, for example, random access memory (RAM), read only memory (ROM), hard disks, floppy disks, compact disks (e.g., CD ROM, DVD ROM, CD RW, etc.), tapes, and/or other memory components, plus associated drives and players for these memory types. The processor 110, memory 112, and the data storage medium 114 are coupled using a local interface 116. The local interface 116 can be, for example, a data bus with accompanying control bus, a network, or other subsystem.

The content server 104 may have various video and input/output interfaces 118 as well as one or more communications interfaces 120. The interfaces 118 can be used to couple the content server 104 to various peripherals, such as a display 122 (e.g., a CRT display, an LCD display, a plasma display, etc.), a keyboard 124, and a user input device 126. The communications interfaces 120 can be comprised of, for example, a modem, a network interface card, and/or a wireless network interface card. The communications interfaces 130 can enable the content server 104 to transmit and receive network-based content via an external network, such as the Internet, a wide area network (WAN), a local area network (LAN), direct data link, or similar wired (e.g., Ethernet) or wireless system (e.g., 802.11-compliant protocols), as discussed above.

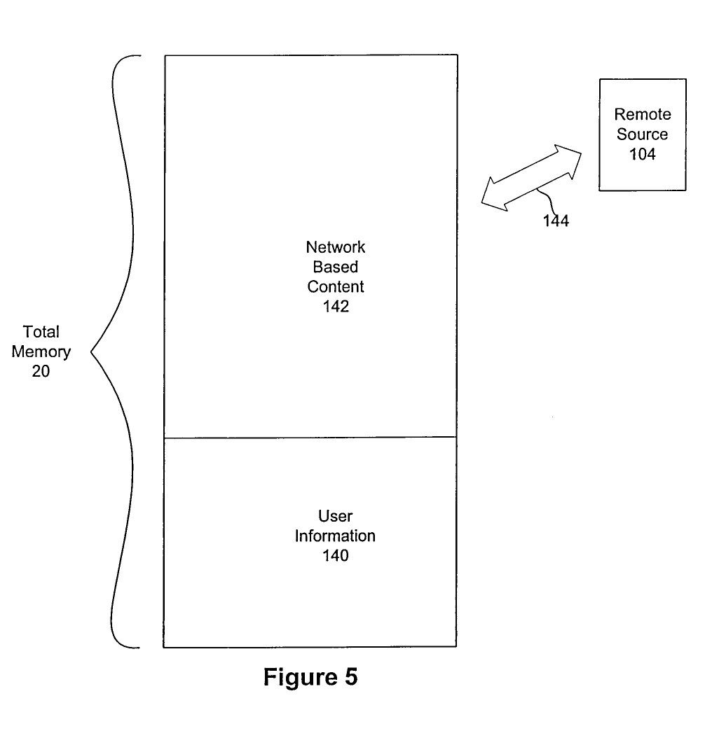

Referring to FIG. 5, a block diagram of memory 20 for mobile telephone 10 is provided. Memory includes the total memory available the mobile telephone 10 (e.g., internal memory and memory cards capable of being internally contained in and/or stored in the mobile telephone 10. The memory 20 includes storage for user information 140 (e.g., information that is necessary for operation of the mobile telephone 10 including all associated features, user entered information, user saved information, etc.) and storage for network based content 142. (e.g., content that can is downloaded, shuffled and re-filled by one or more sources). In one embodiment, the entire amount of memory is always filled up with user information 140 and/or network based content 142. A communication link 144 is established between the remote source 104 and the memory 20 through the mobile telephone 10 and an associated network. As explained in detail below, the network based content is automatically refreshed from an external source (e.g., server 104). The amount of memory available for network based content dynamically decreases as, for example, the user saves network based content to memory 20 of the mobile telephone 10, the user saves other content to memory 20 of the mobile telephone 10 (e.g., the user adds contact information, the user takes pictures with a camera associated with the mobile telephone 10, etc.). Thus, as the amount of user information 140 increases, the amount of memory to store network based content 142 decreases. Likewise, as the amount of user information decreases, the amount of memory to store network based content increases.

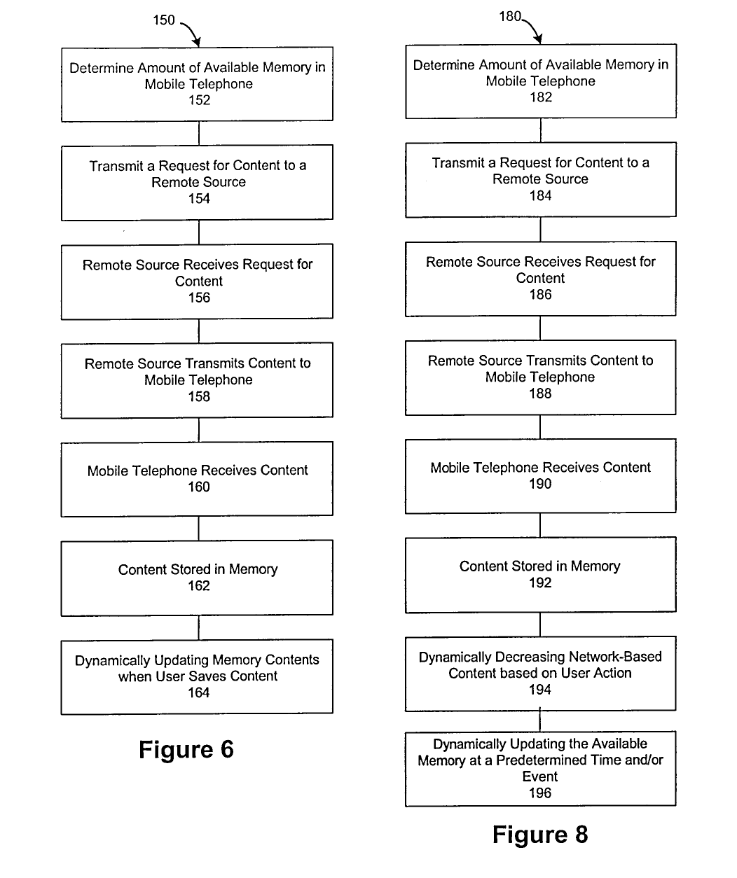

Referring to FIG. 6, a method 150 in accordance with one aspect of the present invention is illustrated. Method 150 assumes that an application on the content server 104 (e.g., content server 104A and/or content server 104B) has information related to network based content. The information may be stored in any suitable manner (e.g., database, spreadsheet, lookup table, etc.). An exemplary use case is when the operator of a mobile telephone network desires to provide users of mobile telephones on the network with a sampling of services and/or products that are available to the users on the network. The method 150 assumes that all devices (e.g., mobile telephone 12, devices associated with network 100, etc.) are associated properly with their respective communication connections and/or networks. The method 150 also assumes that the mobile telephone includes an application program stored in memory 20 suitable to carry out the functions and/or operations described herein.

At step 152, an application resident on the mobile telephone 12 determines the amount of available memory on the mobile telephone 12. Depending on the precise application, the amount of available memory may include any available memory cards associated with the mobile telephone 12. In general, the available memory is the total amount of memory resident on the mobile telephone less any user information that is stored in memory.

At step 154, a request for network-based content is transmitted to a remote source (e.g., content server 104, personal computer 109, etc.) located on the network 100. The request may include the amount of available memory determined at step 152. The request may also include one or more user preferences for network-based content. A user may set user preferences in any manner. For example, the user may manually prioritize the type of network-based content the user desires. Alternatively, the user may be presented with a series of questions, based on the user's answer to the series of questions, an algorithm may determine the user's preferences. One of ordinary skill in the art will readily appreciate that the user's preference may be determined in a wide variety of manners, all of which are deemed to be within the scope of the present invention.

At step 156, the remote source receives the request for network-based content. The remote source may determine from the request how much available memory is available on the mobile telephone and if there exists any user preferences for network-based content. Based upon the available memory and/or user preferences, the remote source will transmit available network-based content to the mobile telephone 12, at step 158. In one embodiment, the content server 104 will transmit new network-based content to completely fill the available memory on the mobile telephone 12. In another embodiment, the remote source will transmit new network-based content to leave a predetermined amount of memory available on the mobile telephone 12 for the user to store user information.

At step 160, the mobile telephone 12 receives the network-based content from the remote source. At step 162, the network-based content is stored in memory. At step 162, memory contents are dynamically updating the memory by deleting and/or overwriting at least a portion of the received network-based content stored in memory when the user stores user information in memory 20. For example, when the user purchases the network-based content and/or otherwise decides to permanently store any portion of the network-based content on the mobile telephone 20, the selected network-based content becomes user information. As user information, the total memory available for receiving additional network-based content is reduced. When the user attempts to store user information that exceeds the available memory, portions of the network-based content may be deleted or otherwise removed to make available memory for the user information to be stored on the mobile telephone 12. The decrease in network-based content occurs dynamically by the application software stored in memory 20, i.e., contents are deleted automatically without user intervention. The deleted network-based content is preferably content that the user is most unlikely not to use. Alternatively, the network-based content to be deleted may be content that the user repeatedly tried, but did not purchase. One of ordinary skill in the art will appreciate that the selection of network-based content to be deleted may based on a variety of factors and/or design criteria, all of which fall within the scope of the present invention.

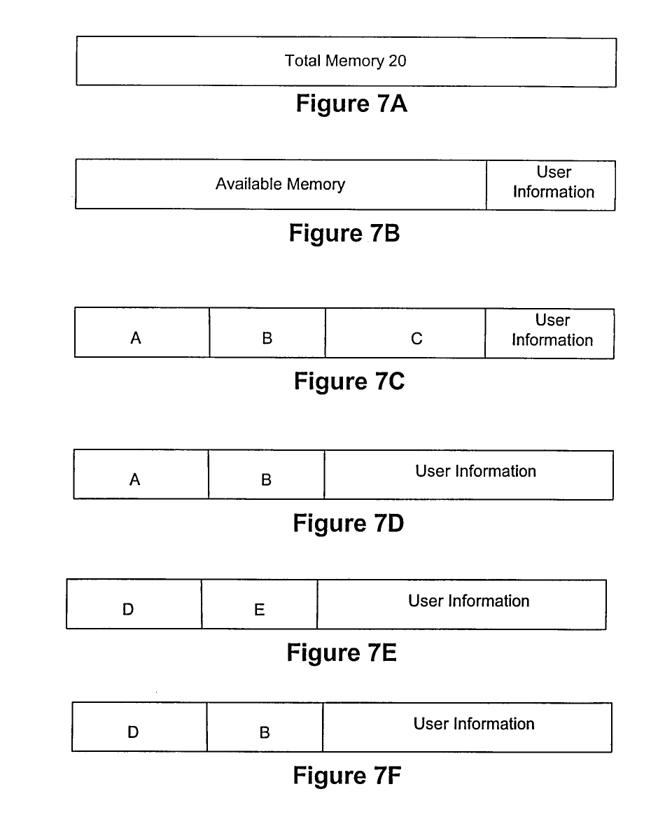

FIGS. 7A-7F are exemplary illustrations of memory management in accordance with the present invention. FIG. 7A illustrates the total memory associated with the mobile telephone. The total memory includes all available memory storage elements capable of being housed in the mobile telephone 10. Such memory includes, for example, random access memory, memory cards capable being inserted into the mobile telephone (e.g., compact flash, secure digital, MultiMedia, XD-picture, Memory Sticks, etc.) and the like. FIG. 7B illustrates a portion of the total memory having stored user information with the remaining amount of the total memory listed as available memory. The user information includes all information necessary for any and all functional features of the mobile telephone 10, user saved information, user entered information, and the like.

FIG. 7C illustrates that network-based content (e.g., applications A, B and C) is loaded in the remaining available memory. The total available memory is preferably loaded with additional applications and/or content for the user to sample, buy, and/or otherwise use. FIG. 7D illustrates a user saving application C. Upon saving application C, application C becomes user information. As shown in FIG. 7D, the available memory is now reduced by the size of application C and the amount of user information is increased by the size of application C. Thus, the amount of available memory to be filled with network-based content will be reduced due to the increase in user information. Likewise, if the user chooses to delete user information, the amount of user information will decrease and the amount of available memory for downloading additional network-based content will increase. One of ordinary skill in the art will readily appreciate the precise manner that memory is freed to save additional user information is may vary greatly and all such variations are included within the scope of the present invention.

The request for network-based content may be sent manually and/or automatically. For example, the request may be manually sent by a user of the mobile telephone 12 at any time the user desires to have new network-based content available on the mobile telephone 12. In another embodiment, the user may set a time and/or date for the request to be sent automatically. In this instance, it may be beneficial for the user to select a day and time that would minimize air time charges if the request is being transmitted through the mobile telephone network. In another embodiment, the request may also be sent when the mobile telephone 12 detects a WLAN. In another embodiment, the request may be sent when the user connects the mobile telephone 12 to a personal computer. In these situations, the request may be transmitted by either the mobile telephone network or the computer network. Preferably, the request is transmitted through the computer network in order to minimize air time charges on the mobile telephone network.

In another embodiment, the request may be transmitted after a user has sampled a certain percentage of the network-based content. For example, if the user samples a threshold percentage of the network-based content, e.g., 50%, and fails to purchase any additional services and/or products, a new request may be transmitted. In another embodiment, a request may be transmitted if the user samples a particular application a threshold number of times without purchasing the content. One of ordinary skill in the art will readily appreciate that the threshold percentage will vary depending on a variety of design and/or cost considerations.

Another exemplary method 180 for managing content stored in a mobile telephone in accordance with the present invention is illustrated in FIG. 7. At step 182, an application resident on the mobile telephone 12 determines the amount of available memory. At step 184, a request for content from the mobile telephone is transmitted to an external source, wherein the request includes an amount of available memory on the mobile telephone 12. The request may also include one or user preferences.

At step 186, the external source receives the request for network-based content. The external source may be any source. Exemplary external sources include, for example, a server, a personal computer, and the like. The external source may determine from the request how much available memory is available on the mobile telephone and if there exists any user preferences for network-based content. Based upon the available memory and/or user preferences, the external source will transmit available network-based content to the mobile telephone 12, at step 188. In one embodiment, the external source will transmit new network-based content to completely fill the available memory on the mobile telephone 12. In another embodiment, the external source will transmit new network-based content to leave a predetermined amount of memory available on the mobile telephone 12 for the user to store user information.

At step 190, the mobile telephone 12 receives content based upon the request for content, wherein the received content corresponds to a substantial portion of the memory available on the mobile telephone. As used herein, a substantial portion of the memory means at least 50% percent of the available memory. More preferably, a substantial portion of the memory includes at 75% of the available memory. Even more preferably, a substantial portion of the memory includes at 90% of the available memory.

At step 192, the mobile telephone 12 stores the received network-based content in memory 20. When the user purchases network-based content and/or otherwise decides to permanently store any portion of the network-based content on the mobile telephone 20, the selected content becomes user information. At step 194, the decrease in network-based content occurs dynamically by the application software stored in memory 20, i.e., contents are deleted automatically without user intervention. The deleted network-based content is preferably content that the user is most likely not to use. Alternatively, the network-based content to be deleted may be content that the user repeatedly tried, but did not purchase. One of ordinary skill in the art will appreciate that the selection of network-based content to be deleted may based on a variety of factors and/or design criteria, all of which fall within the scope of the present invention.

At step 196, a request for network-based content to dynamically update the memory at a predetermined time and/or event is transmitted. One of ordinary skill in the art will readily appreciate the precise manner that memory is freed to save additional user information is may vary greatly and all such variations are included within the scope of the present invention. For example, FIG. 6E illustrates additional applications D and E stored in available memory. In another embodiment, the application contents may be shuffled, as shown in FIG. 6F.

As stated above, the request for network-based content may be sent manually and/or automatically. For example, the request may be manually transmitted by a user of the mobile telephone 12 at any time the user desires to have new network-based content available on the mobile telephone 12. In another embodiment, the user may set a time and/or date for the request to be sent automatically. In this instance, it may be beneficial for the user to select a day and time that would minimize air time charges if the request is being transmitted through the mobile telephone network. In another embodiment, the request may also be sent when the mobile telephone 12 detects a WLAN. In another embodiment, the request may be sent when the user connects the mobile telephone 12 to a personal computer. In these situations, the request may be transmitted by either the mobile telephone network or the computer network. Preferably, the request is transmitted through the computer network in order to minimize air time charges on the mobile telephone network.

In another embodiment, the request may be transmitted after a user has sampled a certain percentage of the network-based content. For example, if the user samples a threshold percentage of the network-based content, e.g., 50%, and fails to purchase any additional services and/or products, a request may be transmitted. In another embodiment, a request may be transmitted if the user samples a particular application a predetermined number of times without purchasing the content. One of ordinary skill in the art will readily appreciate that the threshold percentage will vary depending on a variety of design and/or cost considerations.

In another embodiment of the invention, instead of the total memory being allocated for user information and/or network-based content, the user and/or application designer may allow for a predetermined amount of the total memory to be allocated for network-based content. The predetermined amount may be any amount of the total memory. Preferably, the predetermined amount is a substantially near the total amount of available, so that more network-based content may be added sampled by the user, which may lead the user to purchase additional applications and/or content.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for downloading content to a mobile telephone, the method comprising:
determining an amount of available memory in a mobile telephone;
transmitting a request for content from the mobile telephone to an external source, wherein the request includes the amount of available memory in the mobile telephone;
receiving content based upon the request for content, wherein the received content corresponds to a predetermined portion of the available memory; and
storing the received content in memory;
storing user information in the memory; and
dynamically updating the memory when an associated users stores additional information in memory.

2. The method of claim 1, wherein the request for content includes one or more user preferences.

3. The method of claim 2, wherein the request is transmitted at a predetermined time.

4. The method of claim 3, wherein the request is automatically transmitted.

5. The method of claim 4, wherein the request is automatically transmitted upon detection of wireless local area network.

6. The method of claim 4, wherein the request is automatically transmitted upon connecting the electronic equipment to a personal computer.

7. The method of claim 2, wherein the request is manually selected by an associated user of the electronic equipment.

8. The method of claim 2, wherein the request is manually selected by an associated user action.

9. The method of claim 2, wherein the request is transmitted after a threshold percentage of the content has been sampled by the associated user.

10. The method of claim 1, wherein the external source is a remote server.

11. The method of claim 1, wherein the external source is a personal computer.

12. The method of claim 1, wherein the content is received through a mobile telephone network.

13. The method of claim 1, wherein the content is received through a local area network adapter.

14. The method of claim 13, wherein the local area network adapter is a wireless local area network adapter.

15. A method for managing content stored in a mobile telephone, the method comprising:
transmitting a request for content from the mobile telephone to an external source, wherein the request includes an amount of memory available on the mobile telephone;
receiving content based upon the request for content, wherein the received content corresponds to a substantial portion of the memory available on the mobile telephone;
storing the received content in memory; and
dynamically updating the memory based upon a predetermined time and/or event.

16. The method of claim 15, wherein the event is sampling of the content a predetermined number of times.

17. The method of claim 15, wherein the predetermined time corresponds to a time when access to a network is free and/or a provided at a fee less than a standard fee for access to the network.

18. A computer program stored on a machine readable medium, the program being suitable for requesting content from a remote source, wherein
when the program is loaded in memory in the mobile telephone and executed causes the mobile telephone to transmits a request for content from the mobile telephone to an external source, wherein the request includes an amount of memory available on the mobile telephone, receive content based upon the request for content, wherein the received content corresponds to a substantial portion of the memory available on the mobile telephone; storing the received content in memory; and dynamically updating the memory based upon a predetermined time and/or event.

19. The computer program of claim 18, wherein the request includes at least user preference.

20. The computer program of claim 19, wherein the user preference relates to content that a user may be inclined to purchase in the future.
